(19) United States
(12) Patent Application Publication
(10) Pub. No.: US 2024/0144275 A1
(43) Pub. Date: May 2, 2024

(54) REAL-TIME FRAUD DETECTION USING MACHINE LEARNING

(71) Applicant: Hint, Inc., Pleasanton, CA (US)

(72) Inventors: Muthanna Nischal Ammatanda, Fremont, CA (US); Abraham Benjamin de Waal, San Jose, CA (US)

(21) Appl. No.: 17/976,108

(22) Filed: Oct. 28, 2022

(51) Int. Cl. G06Q 20/40

(52) U.S. Cl. CPC G06Q 20/4016

(57) ABSTRACT

Systems and methods herein describe a fraud detection system. The fraud detection system receives a transaction request comprising a set of transaction data; accesses a set of historical transaction data from one or more historical data sources including at least one microservice database collecting a particular aspect of transactional data processed by a corresponding microservice in support of a tenant in a multitenant environment; anonymizes the set of historical transaction data; generates a weight score for each data source of the one or more historical data sources; generates a fraud score for the set of transaction data, the fraud score generated using a machine-learning model trained to analyze the historical transaction data and the generated weight scores for the one or more historical data sources; determines that the fraud score surpasses a threshold score; and in response to determining that the fraud score surpasses the threshold score, voids the transaction request.

### TECHNICAL FIELD

Embodiments herein generally relate to fraud detection. More specifically, but not by way of limitation, embodiments relate to fraud detection in real-time (or near real-time) for card transactions using machine learning. The card transactions may include credit or debit card transactions in a multi-tenant subscription environment.

### BACKGROUND

Credit card and debit card fraud is a rising form of identity frauds that is impacting people across the world. A fraudulent transaction may occur if a physical card is misplaced or stolen and used for unauthorized in person or online transactions. In some cases, criminals may steal a card number along with a personal identification number (PIN) and security code to make purchases. Card information can also be obtained online via data breaches that then allow criminals to make purchases without needing possession of the physical card.

### BRIEF DESCRIPTION OF THE SEVERAL VIEWS OF THE DRAWINGS

FIG. 1 is a block diagram showing an example point-of-sale system for conducting transactions over a network, according to some embodiments.

FIG. 2 is a block diagram illustrating a networked environment in which the described technology, according to some example embodiments, may be deployed.

FIG. 3 illustrates the training and use of a machine-learning program, according to some embodiments.

FIG. 4 illustrates multiple examples of Personally Identifiable Information (PII), according to some examples.

FIG. 5 illustrates multiple aspects of Protected Health Information (PHI), according to some examples.

FIG. 6 illustrates technical guidelines for Payment Card Industry (PCI) data storage, according to some examples.

FIG. 7 illustrates a networked environment in which the described technology, according to some example embodiments, may be deployed.

FIG. 8 is a diagrammatic representation of a processing environment, in accordance with one embodiment.

FIG. 9 illustrates a networked environment in which the described technology, according to some example embodiments, may be deployed.

FIG. 10 is a schematic diagram illustrating aspects of encryption, according to some examples.

FIG. 11 illustrates a control table, according to an example.

FIG. 12 illustrates an encrypt sensitive data control table, according to an example.

FIG. 13 illustrates example encryption results in tabular form, according to some examples.

FIG. 14 illustrates data production structures, according to some examples.

FIGS. 15-16 illustrate operations in data encryption procedures, according to some examples.

FIG. 17 is a flow diagram of an example method for detecting fraudulent card transactions, according to some embodiments.

FIG. 18 is a block diagram illustrating a software architecture, which can be installed on any one or more of the devices described herein, according to some embodiments.

FIG. 19 is a diagrammatic representation of the machine within which instructions for causing the machine to perform any one or more of the methodologies discussed herein may be executed, according to some embodiments.

### DETAILED DESCRIPTION

Systems and methods herein describe a fraud detection system used for pre-declining card transactions. The fraud detection system identifies and declines fraudulent transactions before the transaction has been processed instead of after. Traditional systems apply fraud detection mechanisms from the issuer's side (e.g., the bank) after the transaction has been processed. For some embodiments, the proposed fraud detection system is an improvement to traditional systems because it provides fraud detection capabilities before the transaction has been processed and mitigates complications in handling fraudulent transactions.

The fraud detection system leverages historical data to analyze an incoming transaction request. For example, the fraud detection system can intelligently analyze the validity of an incoming transaction request based on historical data, such as purchase patterns of a particular customer, trends in product purchase history, and the like.

The fraud detection system receives a transaction request. The transaction request may be received by a client device (e.g., a payment reader). The transaction request includes transaction data such as information about the payment instrument (e.g., credit card, debit card), the customer (e.g., personal identifiable information), the product (e.g., the price of the product, the quantity of the product that was purchased) and the merchant (e.g., the location of the transaction). The fraud detection system accesses historical transaction data from historical databases to validate the transaction request. For example, the fraud detection system accesses historical transaction data from a customer database, a payment database, a merchant database, and a card database.

The fraud detection system further generates a weight score for each of the data sources (e.g., the historical databases). The weight scores may be generated to prioritize data sources that contain a larger dataset or may otherwise provide a more accurate representation of the received transaction data. In some examples, the fraud detection system generates the weight scores for each of the data sources using a machine-learning model. After generating the weight scores, the fraud detection system generates a fraud score for the received transaction request. The fraud score is based on the historical transaction data and the weight scores for each of the data sources. If the fraud score is at or above a threshold score, the fraud detection system determines that the transaction is likely a fraudulent transaction and voids the transaction. If the fraud score is below the threshold score, the fraud detection system determines that the transaction is likely a valid transaction and processes the transaction as usual.

The disclosed fraud detection system provides technical advantages over existing methodologies by leveraging a technical solution that involves machine-learning techniques that allow for the analysis of large amounts of data (e.g., historical data) and accurate categorization the data (e.g., based on the weight scores) to determine a fraud score for a particular transaction.

Further details of the fraud detection system are described in the paragraphs below.

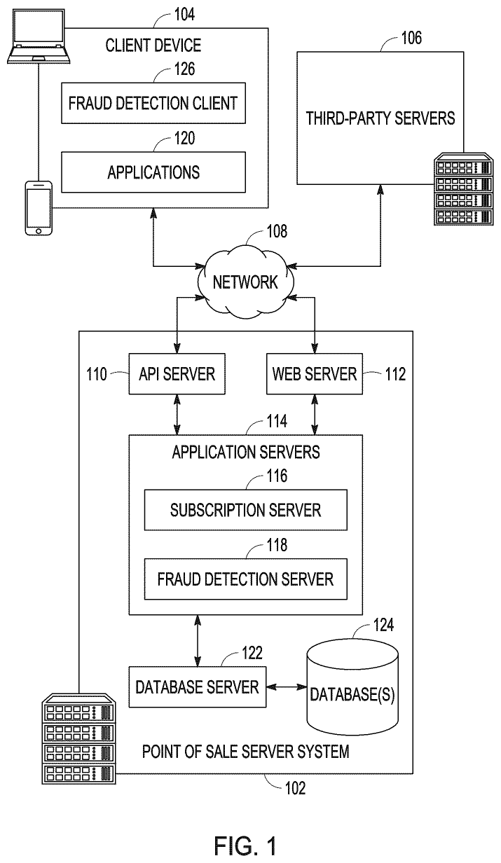

FIG. 1 is a block diagram showing an example point-of-sale system for conducting transactions over a network. The point-of-sale system includes multiple instances of a client device 104, each of which hosts a number of applications, including a fraud detection client 126 and other applications 120. Each fraud detection client 126 is communicatively coupled to other instances of the fraud detection client 126 (e.g., hosted on respective other client devices 104), a point-of-sale server system 102, and third-party servers 106 via a network 108 (e.g., the Internet). The applications 120 can also communicate with other locally-hosted applications 120 using Applications Program Interfaces (APIs).

The point-of-sale server system 102 provides server-side functionality via the network 108 to a fraud detection client 126. While certain functions of the point-of-sale system are described herein as being performed by either a fraud detection client 126 or by the point-of-sale server system 102, the location of certain functionality either within the fraud detection client 126 or the point-of-sale server system 102 may be a design choice. For example, it may be technically preferable to initially deploy certain technology and functionality within the point-of-sale server system 102 but to later migrate this technology and functionality to the fraud detection client 126 where a client device 104 has sufficient processing capacity.

The point-of-sale server system 102 supports various services and operations that are provided to the fraud detection client 126. Such operations include transmitting data to, receiving data from, and processing data generated by the fraud detection client 126. This data may include transaction data, customer data, product data, subscription data and provider data, as examples. Data exchanges within the point-of-sale server system 102 are invoked and controlled through functions available via user interfaces (UIs) of the fraud detection client 126.

Turning now specifically to the point-of-sale server system 102, an API server 110 is coupled to, and provides a programmatic interface to, application servers 114. The application servers 114 are communicatively coupled to a database server 122, which facilitates access to a database 124 that stores data associated with the transactions processed by the application servers 114. Similarly, a web server 112 is coupled to the application servers 114 and provides web-based interfaces to the application servers 114. To this end, the web server 112 processes incoming network requests over the Hypertext Transfer Protocol (HTTP) and several other related protocols.

The API server 110 receives and transmits transaction data (e.g., commands and transaction data) between the client device 104 and the application servers 114. Specifically, the API server 110 provides a set of interfaces (e.g., routines and protocols) that can be called or queried by the on demand funding client 126 in order to invoke functionality of the application servers 114. The API server 110 exposes various functions supported by the application servers 114, including account registration, subscription creations and management, the processing of transactions, via the application servers 114, from a particular fraud detection client 126 to another fraud detection client 126.

The application servers 114 host a number of server applications and subsystems, including, for example, a subscription server 116 and a fraud detection server 118. The subscription server 116 implements functionalities for creating and managing subscriptions between multiple client devices 104.

The fraud detection server 118 provides functionalities for pre-declining fraudulent card transactions based on an evaluation of the transaction. Further details regarding the fraud detection server 118 are provided below.

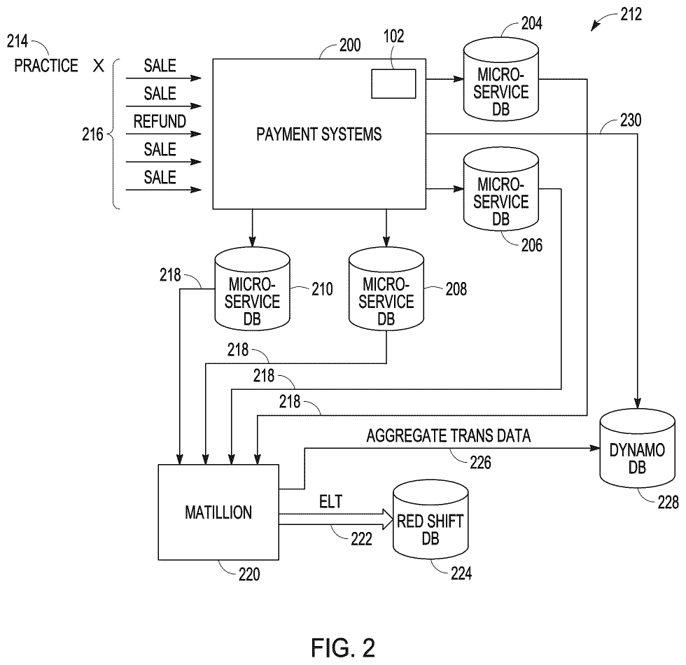

With reference to FIG. 2, in some examples, the point-of-sale server system 102 is included in a (fraud-detecting) payment systems network 200 (or conglomerate of payment systems). The payment systems network 200 may operate as (or include) a microservices depot including connections to one or more microservices databases, for example, including the illustrated microservice databases 204, 206, 208, and 210. The payment systems network 200 and microservice databases may operate in a multitenant environment 212 including at least one medical practice 214, as an example tenant in the multitenant environment 212.

In some examples, the payment systems network 200 includes a number of microsystems that each provide an associated microservice for a given tenant in the multitenant environment. Example microservices may include a point-to-point (P2P) encryption microservice (that writes to the microservice database 204, for example), a global gateway microservice (that writes to the microservice database 206, for example), a card microservice (that writes to the microservice database 208, for example), and a payment microservice (that writes to the microservice database 210, for example). Other microservices are possible.

In an example transaction, a patient at the practice 214 swipes a card to pay for a product or service. Many other different types of transactions 216 (such as sales (purchase), refunds, credits, loyalty program redemptions and so forth) may be received from any one or more of the patients at any one of more of the tenants in the multitenant environment 212. The numbers of patients and tenants can run into the thousands or even millions. It will be appreciated that the number, variety, and complexity of the transactions 216 can be very high. In some examples, the payment systems network 200 is configured to process this great multiplicity of transactions to check for fraud in near real-time.

When the example transaction is received at the practice 214, at least one of the microservices in the payment systems network 200 is invoked based on the nature or type of the transaction and writes out to its associated microservice database. As the transactions 216 each proceed, each microservice database 204-210 collects its own related part of the transaction information; for example, the microservice database 210 collects information for payment transactions (e.g. cash transactions), while the microservice database 208 collects information for (credit) card transactions. Other microservices are possible.

In some examples, the microservices depot includes a further microservice (not shown) called a ledger microservice. An associated ledger microservice database stores aspects related to transactional bookkeeping, recording aspects such as a transaction ID, a transaction dollar amount, details of an item, product or service purchased, and so forth. The ledger microservice operates as a ledger and keeps a tally of such details. The ledger information may be distributed or shared with all the other microservices.

In some examples, the data stored in microservice databases 204-210 is transmitted (or otherwise made available) at 218 to an “extract, load and transform” (ELT) tool, such as the illustrated ELT tool 220. An example ELT tool 220 may be (or include) a Matillion™ ELT tool 220. For all of the microservices (including the ledger microservice), the ELT tool 220 can perform ELT operations based on the continuous data supplied to it from the microservices databases 204-210, including, in some examples, the ledger microservice database.

In some examples, an output 222 of the ELT tool 220 includes normalized data or online transaction processing (OLTP) data that has been extracted, loaded, and transformed into star schemas and stored in a database, such as the Redshift database 224. In some examples, the ELT tool 220 extracts OLTP data, data from external online transaction processing databases, and data from any one or all of the microservice databases; loads the data; transforms this data into an abstracted, online analytical processing structure; and stores this as one or more star schemas in the Redshift database 224.

In some examples, in parallel with the ELT process, the ELT tool 220 also aggregates transactional information as part of its transformation, and then pushes at 226 this aggregated data for storage in a Dynamo database 228. In one sense, this operation may be considered to be moving information from what is a reporting infrastructure into a transaction processing resource. At 230, the payment systems network 200 and each of the microservices have access to this Dynamo database 228 for fraud detection purposes and evaluation against near real-time aggregated information and ongoing real-time transactions 216.

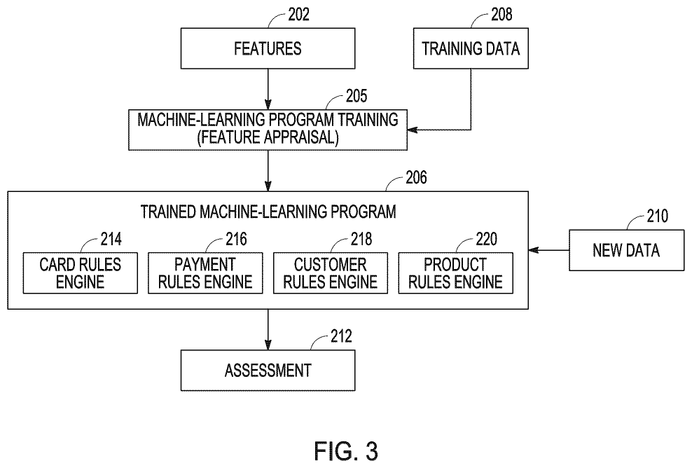

This aggregation of transactional data allows for the creation of fraud detection rules or threshold fraud parameters. Rules or threshold parameters may be based, for example, on an average monthly volume per practice for an individual practice (tenant) or patient. Other rules and thresholds are described further below in connection with machine learning with reference to FIG. 3.

As opposed merely to providing fixed fraud detection rules or threshold parameters, some examples allow for dynamic rule setting and flexibility in configuration. Assume a new practice joins a medical network as an example multitenant environment. Here, based on the type of practice it is and based on what has been seen historically across sets of practices, examples allow different machine learning algorithms to predict what an average sales price for use as a fraud detection trigger might be for the new practice. The new practice can be immediately protected and “inherit” existing rules and threshold parameters, accordingly.

Examples can also predict that a purchase, for example a neurotoxin like Botox, includes a certain average reorder time or purchase frequency. A purported reorder transaction for the same product that is received in too short a time, or at an increased frequency, is potentially fraudulent. Based on such purchase patterns, fraud scores for a given transaction can be developed and processed, accordingly. This is described in greater detail below.

FIG. 3 illustrates the training and use of a machine-learning program, according to some embodiments. In some embodiments, machine-learning programs (MLPs), also referred to as machine-learning algorithms or tools, are utilized to perform operations associated with malware classification. Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 308 in order to make data-driven predictions or decisions expressed as outputs or assessment 312. Although some embodiments are presented with respect to a few machine-learning tools, the principles presented herein may be applied to other machine-learning tools.

In some embodiments, different machine learning tools may be used. For example, Logistic Regression (LR), Naive-Bayes, Random Forest (RF), neural networks (NN), matrix factorization, and Support Vector Machines (SVM) tools may be used for classifying or scoring transaction data.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a prediction probability to classify an image as digitally manipulated or not. The machine-learning algorithms utilize the training data 308 to find correlations among identified features 302 that affect the outcome.

The machine-learning algorithms utilize features 302 for analyzing the data to generate an assessment 312. The features 302 are an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs. In one embodiment, the features 302 may be of different types. For example, the features 302 may be features of historical transaction data.

The machine-learning algorithms utilize the training data 308 to find correlations among the identified features 302 that affect the outcome or assessment 312. In some embodiments, the training data 308 includes labeled data, which is known data for one or more identified features 302 and one or more outcomes, such as detecting fraudulent transactions.

With the training data 308 and the identified features 302, the machine learning tool is trained during machine-learning program training 305. Specifically, during machine-learning program training 305, the machine-learning tool appraises the value of the features 302 as they correlate to the training data 308. The result of the training is the trained machine-learning program 306.

When the trained machine-learning program 306 is used to perform an assessment, new data 310 is provided as an input to the trained machine-learning program 306, and the trained machine-learning program 306 generates the assessment 312 as output. For example, when transaction data is received, the historical transaction data is accessed, and the weights of the corresponding data sources are computed, the machine-learning program utilizes features of the historical transaction data to determine if the received transaction request is fraudulent or not.

In some examples, the trained machine-learning program 306 includes a series of rules engines. Each rules engine includes a list of rules that the incoming transaction request is evaluated against before providing the assessment 312. For example, the trained machine-learning program 306 may include a card rules engine 314, a payment rules engine 316, a customer rules engine 318, and a product rules engine 320. The card rules engine 314 includes a set of rules that the card data associated with transaction request must be evaluated against before providing the assessment 312. The payment rules engine 316 includes a set of rules that the payment data associated with the transaction request must be evaluated against before providing the assessment 312. The customer rules engine 318 includes a set of rules that the customer data associated with the transaction must be evaluated against before providing the assessment 312. The product rules engine 320 includes a set of rules that the product data must be evaluated against before providing the assessment 312.

In some examples, training data for machine learning purposes is aggregated and encrypted (or anonymized) in a multitenant environment. Some fraud detection examples relate to or include data aggregation and anonymization in multi-tenant environments or networks and, in some examples, to a data aggregator and anonymizer that can encrypt sensitive data received from multiple tenants as data sources. The sensitive data may include PII, PHI and PCI information. In some examples, anonymized data can be aggregated for multi-faceted testing without disclosing sensitive aspects. In some examples, the aggregated data can be selectively unencrypted to a given tenant.

Results derived from an analysis of “big data” can generally be improved if the volume of test data is significant. Typically, the larger the volume of test data, the more accurate an analysis of it will be. For example, there is greater chance to identify data outliers and trends in a significant body of data. Data aggregation, however, is not easy. It may be aggregated from different sources, but each source will likely have different methods of data protection with which to comply. Each source will also very often have different data content and configuration, and this may conflict with data configuration of other sources. This aggregation of disparate sources of protected information presents technical challenges, particularly in multi-tenant networks or environments. The more data that is collected, the more complicated the security protocols become and the greater the risk of inadvertent disclosure or malicious access to it. Great care is required not to disclose encrypted information to third-party sources of aggregated data, or third-party “big data” analyzers scrutinizing collected data for discernible trends or machine-learning purposes, for example.

According to some example embodiments, techniques and systems are provided for data aggregation and anonymization in multi-tenant networks or environments. In some examples, a data aggregator and anonymizer platform can encrypt sensitive data received from multiple tenants as data sources. The sensitive data may include PII, PHI, and PCI information. In some examples, anonymized data can be aggregated for multi-faceted testing without disclosing sensitive aspects. In some examples, a portion of the aggregated data can be selectively unencrypted and returned or presented to a tenant that was the original source or keeper of that portion of the aggregated data. The remainder of the portions are not unencrypted and may continue to form part of a body of test data.

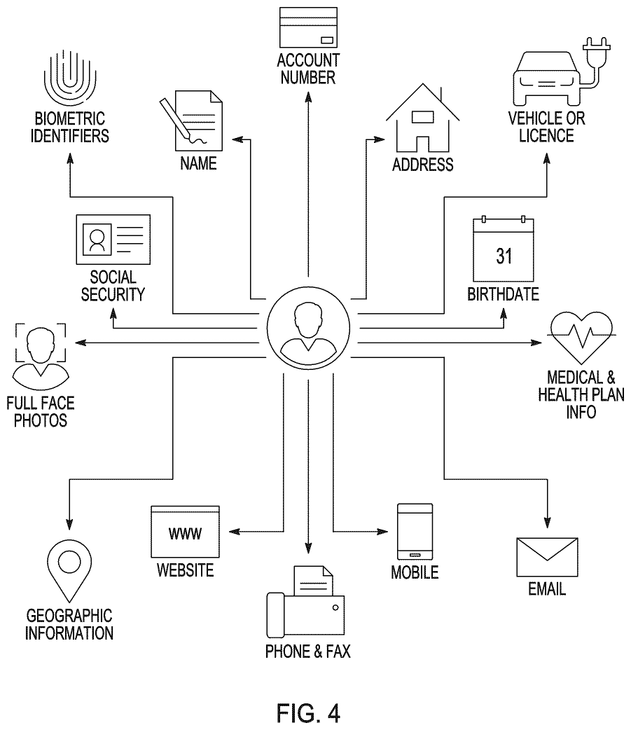

FIG. 4 is a diagram showing multiple examples of PII. According to NIST 1100-522, PII is any information about an individual maintained by an agency, including any information that can be used to distinguish or trace an individual's identity, such as name, social security number, date and place of birth, mother's maiden name, or biometric records, and any other information that is linked or linkable to an individual, such as medical, educational, financial, and employment information.

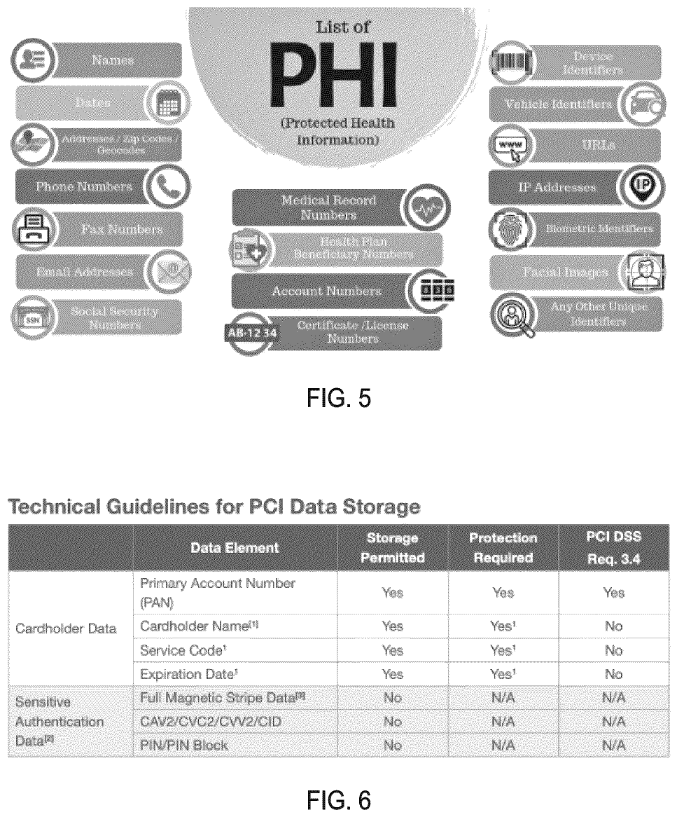

FIG. 5 is a diagram showing multiple examples of PHI. HIPAA Privacy Rules define PHI as “Individually identifiable health information, held or maintained by a covered entity or its business associates acting for the covered entity, that is transmitted or maintained in any form or medium (including the individually identifiable health information of non-U.S. citizens).” HIPAA Privacy Rules also stress genetic information as health information.

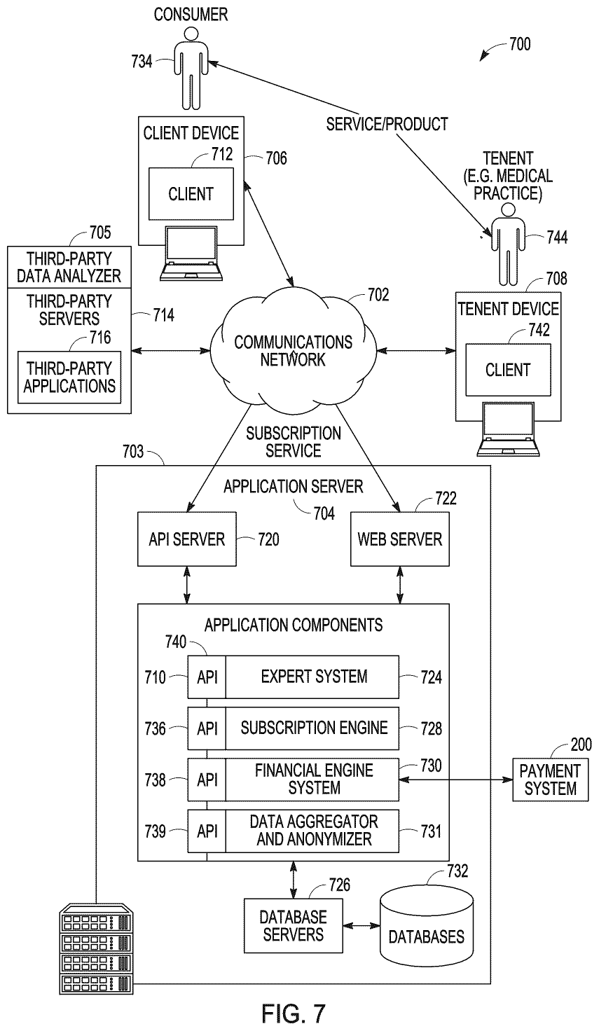

FIG. 6 is a table indicating technical guidelines for PCI data storage. PCI compliance is mandated by credit card companies to help ensure the security of credit card transactions in the payment industry. PCI compliance refers to the technical and operational standards that businesses follow to secure and protect credit card data provided by cardholders and transmitted through card processing transactions. PCI standards for compliance are developed and managed by the PCI Security Standards Council. The data elements relating to card holder name, service code, and expiration date must be protected if stored in conjunction with the Primary Account Number (PAN). This protection should be per PCI Data Security Standard (DSS) requirements for general protection of the cardholder data environment. Additionally, other legislation (e.g., related to consumer personal data protection, privacy, identity theft, or data security) may require specific protection of this data or proper disclosure of a company's practices if consumer related personal data is being collected during the course of business. PCI DSS, however, does not apply if PANs are not stored, processed, or transmitted. The sensitive authentication data must not be stored after authorization, even if encrypted. Full Magnetic Swipe Data includes full track data from a magnetic stripe, magnetic stripe image on a chip, or elsewhere.

Fundamental problems that may arise when processing data in strict compliance to a regulated environment, involving PPI, PHI, or PCI for example, can occur at a confluence of healthcare and treatment information records. One challenge includes simulating a set of problems in production data using test data. For a single medical practice, for example, subscribing along with other medical practices (tenants) to a subscription service (for example) in a multi-tenant network, using a small set of test data based on its own production data may limit the body of test data that can be assembled. On the other hand, trying to build a bigger set of test data by incorporating data from other tenants accessible in the multi-tenant network runs a serious risk of privacy invasion and breach of compliance laws. Further, a desire to collect a large body of data for testing and analysis may include sourcing data that is external to the multi-tenant network and may involve the participation of third parties to analyze the data (e.g., “big data” analysis). Thus, data protection laws prevent a mere aggregation of production data for test purposes.

In other aspects, a further challenge is to simulate realistically, in test environments, what is really happening in production environments. It is difficult to obtain a representative sample of test data that actually and realistically reflects production conditions of whatever aspect the tenant may be developing (for example, an updated health service to patients, a new product offering, or an enhanced online functionality).

In further challenging aspects, production and test systems usually have layers. Lower layers can be accessed by many people, while higher layers can be accessed by relatively few. Access and security protocols differ across layers. In a regulated environment, one cannot easily bring down test information into lower layers because this may violate one or more compliance laws since wider access to this information is provided.

In order to address these and other challenges, some present examples, at a high level, classify and encrypt test information, in particular sensitive information contained in the test information, before it is brought down to lower layers. A representative sample of anonymized test data is made available for testing and, in some examples, is configurable based on data fields that might remain or are encrypted, among other factors. Once the encrypted information is brought down to lower layers, the anonymized test data may be used for a variety of testing purposes during development of a service or product, as discussed above.

Some present examples aggregate data to create a body of test data. The aggregated data may include data sourced from sources other than a single tenant (in other words, an aggregation of multi-tenant or multi-party data). For testing purposes, data analysis, or machine training purposes, an enhanced body of test data may be useful to a tenant or third-party data analyzer even though not all of the aggregated data may have been sourced from it. In this situation, a complicated cross-matrix of protection protocols such a PII, PHI, and PCI may apply, and each tenant may be entitled only to view the portion of the data that it supplied (or at least view an unencrypted version of that data). Present examples of a data aggregator and anonymizer platform facilitate the creation and access to such combined test data, yet still allow and greatly facilitate compliance with data protection laws in doing so.

In cloud-based and other modern systems (e.g., Software-as-a-Service (SaaS) platforms and so forth), most enterprises rely very heavily on third-party applications to process data. Some of these applications may include “big data” processing systems. The enterprise cannot physically control what these third parties do with their data. While inter-party agreements restricting data access and publication may be established, there is always a possibility of a rogue actor acting outside the agreed terms. A rogue actor at one tenant in a multi-tenant network might use network credentials to access another tenant to look up prohibited data. The accessed data might be used for exploitation or ransomware purposes, for example.

Thus, in some present examples, a data aggregator and anonymizer can aggregate and provide anonymized data that, even if accessed by a rogue actor, does not contain any identifying information. In some examples, a data encryption key is used to encrypt test data. In some examples, a decryption key to unlock test data is destroyed. In some examples, a decryption key to unlock a portion of aggregated test data is provided only to the tenant supplying that portion. The decryption key disallows decryption of any other data. The tenant as a source of data is thus placed in the same (unencrypted) position it was before supplying a portion of data to be aggregated, yet has enjoyed the benefit of results and analysis derived from a much larger body of test data sourced from many other, if not all, tenants in a multi-tenant network. The tenants are reassured that any contributed data that has been aggregated and shared with another tenant or third-party data analyzer has nevertheless remained encrypted for purposes such as testing, “big data” analysis, machine learning, and so forth.

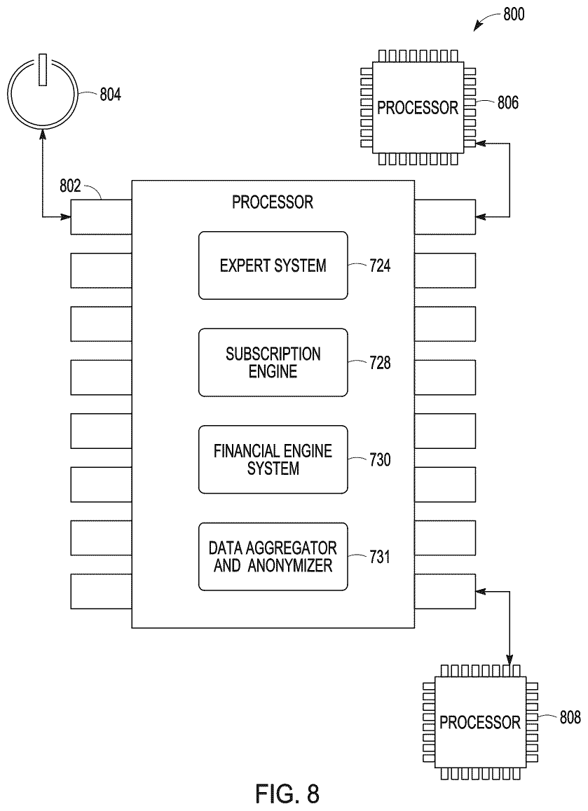

FIG. 7 illustrates a networked multi-tenant network 700 in which a communications network 702 communicatively couples application servers 704 at a subscription service 703, a user device 706, a tenant device 708, and third-party servers 714. The third-party servers 714 may be accessed and operated by a third-party data analyzer 705 (e.g., a “big data” company), for example. The third-party servers 714 host third-party applications 716.

The user device 706 is accessed by a user 734 and processes operations and applications (e.g., a browser application, or commercial platform) sourced from or associated with a tenant 744. The tenant 744 may include a medical practice or service provider operating in a group of networked practices, for example. The user 734 may be a patient of the medical practice, for example. The tenant device 708 is accessed and operated by the tenant 744 to host and process tenant operations and applications 742. In some examples, the multi-tenant network includes a great multiplicity of tenants 744, each communicatively coupled with the subscription service 703.

The application servers 704 include an API server 720 and a web server 722 which, in turn, facilitate access to several application components 718 that include an expert system 724, a subscription engine 728, a financial engine system 730, and a data aggregator and anonymizer 731. Each of these components is provided with a respective API, namely an API 710, an API 736, an API 738, and an API 739.

The application components 718 are communicatively coupled to database servers 726 which in turn facilitate access to one or more databases 732.

In an example scenario, a tenant 744 (e.g., a medical practice) may wish to provide offerings (e.g., products or services) to a user 734 (e.g., a patient), either as a once-off/one-time delivery or as part of a subscription plan which has a recurrence. In this example, the medical practice 744 may also wish to provide the patient 734 with the option of paying for a health product or consultation as a once-off payment, as a subscription payment, or as a combination of a once off payment and a subscription payment.

At a high level, the expert system 724 operates to enable an expert in a particular vertical (e.g., the medical practice 744) to define and manage a plan for the delivery of various products and services to its patients 734. An expert system 724 is accordingly specifically constructed and programmed for the creation of a plan for the delivery of a specific product or service in a particular product or service vertical.

The subscription engine 728 is responsible for the automated management of a plan (which may or may not include any number of subscriptions to products or services).

The financial engine system 730 is responsible for communicating financing opportunities related to a plan to one or more financiers (e.g., who may operate as a provider, or who may be a third party accessing the financial engine system 730 via the third-party applications 716). In some examples, the financial engine system 130 may include or be connected to the payment systems network 200 and microservices discussed above in relation to FIG. 2.

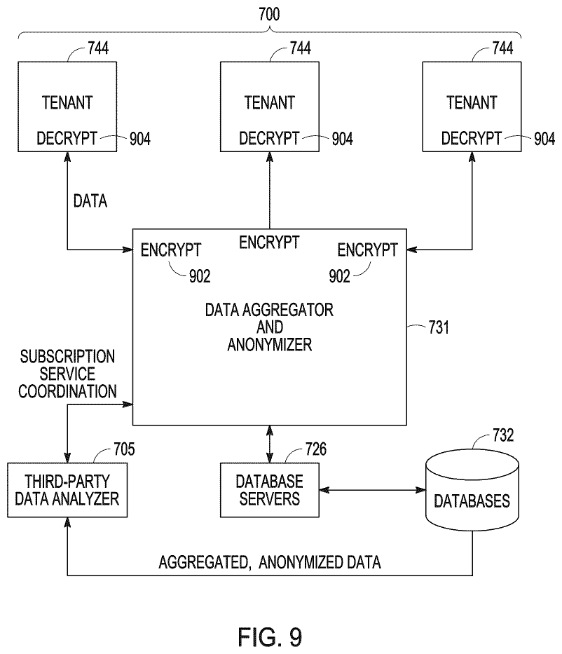

FIG. 8 is a diagrammatic representation of a processing environment 800, which includes a processor 806, a processor 808, and a processor 802 (e.g., a GPU, CPU, or combination thereof). The processor 802 is shown to be coupled to a power source 804, and to include (either permanently configured or temporarily instantiated) modules, namely the expert system 724, the subscription engine 728, the financial engine system 730, and the data aggregator and anonymizer 731. The expert system 724 operationally supports a guided process for the selection of products or services, as well as the attributes of such products and services (e.g., quantity (units), a frequency of delivery and number of deliveries), to include in a subscription.

The subscription engine 728 operationally calculates and presents information relating to overall options related to a subscription for bundled purchase, and the financial engine system 730 operationally allows third parties (e.g., lenders) to view financing opportunities and accept or reject such financing opportunities for subscriptions (or bundles of subscriptions) generated by the subscription engine 728.

As illustrated, the processor 802 is communicatively coupled to both the processor 806 and processor 808 and receives data from the processor 806, as well as data from the processor 808. Each of the processor 802, processor 806, and processor 808 may host one or more of an expert system 724, a subscription engine 728, a financial engine system 730, and a data aggregator and anonymizer 731.

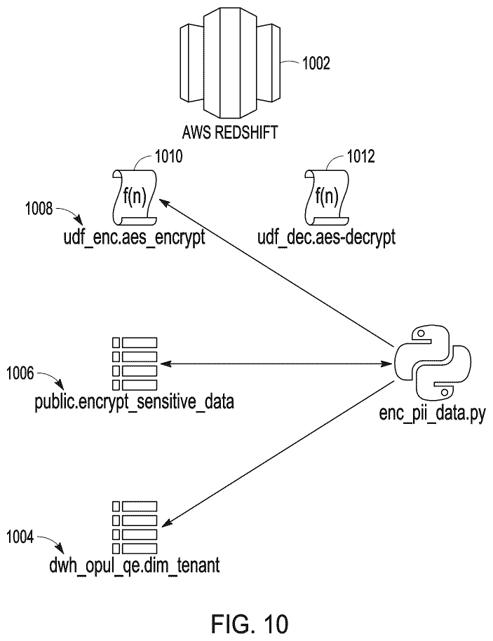

With reference to FIG. 9, in some examples, a tenant 744 in a multi-tenant network 700 may wish to create a testing environment in which to develop a new product or service. To that end, in present examples, the tenant 744 can contact the subscription service 703 and request an aggregation of test data or an analysis of a body of data to help in developing the product or service. The subscription service 703 invokes the data aggregator and anonymizer 731 shown in the view. The tenant 744 may contribute some data, such as production data, to be aggregated or anonymized for test purposes. Some of this production data may be covered by PII, PHI, or PCI requirements and will therefore require appropriate treatment before it can be analyzed by or shared with others. As described more fully below, the aggregated test data is classified to identify sensitive data and encrypted accordingly. The test data is aggregated by the data aggregator and anonymizer 731 to assist in simulating production conditions in which to test the tenant's proposed product or service. In some examples, a plurality of tenants 744 may request an analysis of their respective production data or a simulation of a real-life real-time production environment.

The data aggregated by the data aggregator and anonymizer 731 may be derived from a number of different data sources to assist in creating a realistic test environment or a rich body of data for analysis and training, for example. In some examples, the data may be sourced from a number of sources, without limitation. A data source may include, for example, a single tenant in a network, a plurality of tenants in a network, a single third party outside of a network, or a plurality of third parties outside of a network. Tenants or third parties may be sources of application data, web-based traffic data, or other types of data. Tenants and third parties may offer analysis tools and machine learning models, or other services.

Whether requested by a single tenant 744, or several tenants 744, the aggregated data may comprise a complicated cross-matrix of protection protocols such as PII, PHI, and PCI. Each tenant 744 may be entitled only to view a portion of the data that it supplied or, if permitted, an unencrypted version of that data.

In some examples, data sent by a tenant or accessed by the data aggregator and anonymizer 731 is encrypted at 902 upon receipt or a grant of access. In some examples, when test data, or analyzed data results, are sent back to a tenant 744, this portion of the data is decrypted at 904. These processes are described more fully below. The aggregated and anonymized data is stored in a database, such as the one or more databases 732 described above. Present examples of a data aggregator and anonymizer 731 facilitate the creation and access to combined test data, yet still allow and greatly facilitate compliance with data protection laws in so doing.

In some examples, one or more third-party data analyzers 705 may request access to the aggregated and anonymized data stored in the database 732 for purposes of analyzing it to support the tenant's product or service development mentioned above. A third-party data analyzer 705 may be contracted by the subscription service 703, or a tenant 744, to perform data analysis. With appropriate authorization, the data analyzer 705 may be granted access to the data stored in the database 732. To the extent any access is granted, or to the extent a rogue actor may be at work, the aggregated data stored in the database 732 remains anonymized and yields no sensitive information. The data stored in the database 732 may be safely used by the data analyzer 705, or a tenant 744, or the data aggregator and anonymizer 731, in a number of ways including, for example, data analysis, the development of models for machine learning, and for other purposes.

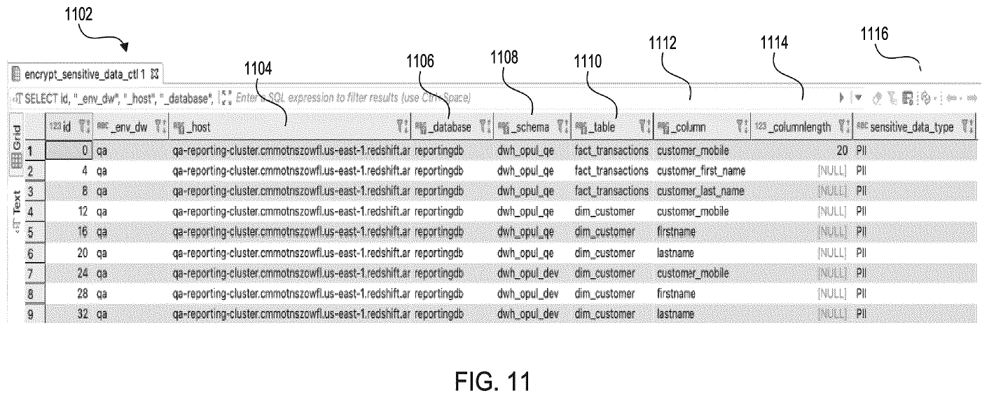

With reference to FIG. 10, some examples, particularly those that utilize the cloud or cloud-based services, include layers, such as software, application, or storage layers, responsible for or utilized in certain aspects of data usage and processing from an origin to post-production. One aspect includes encryption. An example encryption can include an Advanced Encryption Standard (AES). AES follows a symmetric encryption algorithm, i.e., the same key is used to encrypt and decrypt the data. AES supports block lengths of 528, 592, and 556 bits. One example, in a data analytics or reporting tier, includes Amazon Web Services (AWS) Redshift 1002 for encryption and decryption. Redshift is used in some examples to encrypt and decrypt data in various layers. Other encryption software is possible.

In some examples, an AES encryption level is specific to a database persistence layer, for example as shown in FIG. 10. At a first layer 1004, stored data is sourced from one or more tenants 744 and aggregated. At layer 1006, sensitive data in the aggregated data is identified and encrypted. These operations may occur at the data aggregator and anonymizer 731 using database 732 (FIG. 7), for example. Sensitive data is scrambled, hashed, or randomly keyed in some examples. At layer 1008 (for example a lower, widely distributed layer), data is encrypted at 1010 so that it is rendered anonymous. Users operating in this lower level layer 1008 have no access to sensitive data, or if access is obtained, the data is meaningless because it has been anonymized. The data can be decrypted at 1012 as needed for authorized provision to a tenant seeking full access to their data. These encrypt/decrypt operations may occur at the data aggregator and anonymizer 731 or at a tenant 744 (FIG. 7), in some examples. The aggregated, anonymized data may be stored in database 732 (FIG. 7).

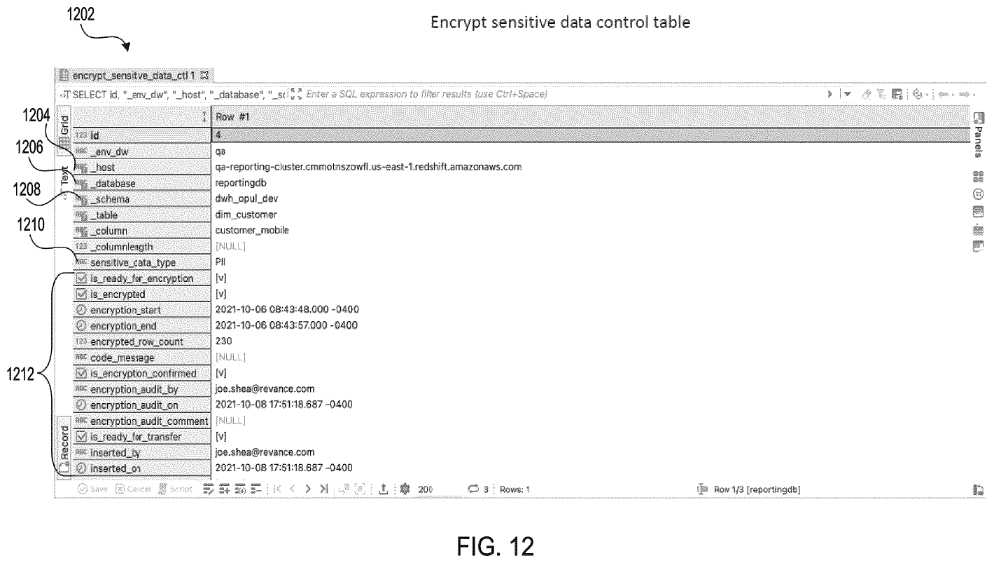

FIG. 11 shows an example of a control table 1102. The table may form part of a data structure in one of the databases 732, for example. The control table 1102 is used in operations including the identification, classification, encryption, and/or anonymization of sensitive data. The control table 1102 may include metadata relating to sensitive and other data. For example, the control table 1102 may include columns relating to one or more aspects of data. In some examples, this data is aggregated data collected from a number of tenants or third parties. Some aspects of the data may, or may not, relate to sensitive information of the type discussed above. Column 1104 identifies a data host or source of data, column 1106 identifies a database storing data, column 1108 identifies a schema for data, column 1110 identifies a data table for data, column 1112 identifies a data column, column 1114 identifies a column length, and column 1116 identifies a sensitive data type. In the illustrated example, the sensitive data type includes PII. The control table 1102 maps out, from a compliance point of view, how the various elements of the aggregated data should be treated (for example, encrypted, permanently deleted, or otherwise anonymized in some manner).

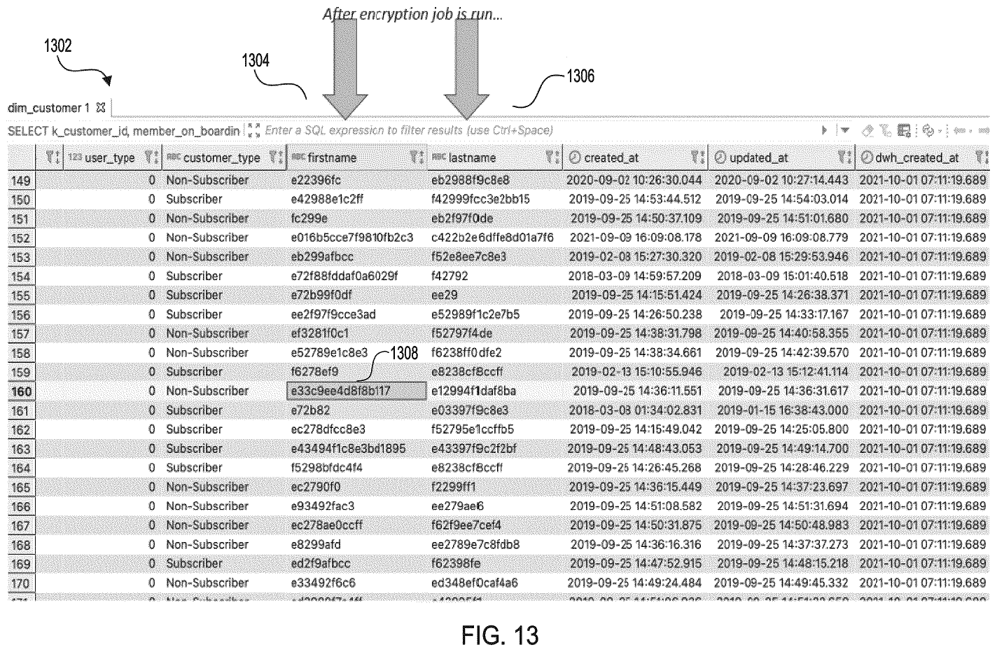

FIG. 12 shows an example of an encrypt sensitive data control table 1202. Some of the aspects of data shown in the control table 1102 are again visible in the encrypt sensitive data control table 1202 as host 1204, database 1206, schema 1208, and so on. In particular, an identification of the sensitive PII data is again provided at 1210. In the illustrated example, the encrypt sensitive data control data table 1202 also provides details of an encryption of the sensitive data in the region marked 1212 in the table. In this example, the encryption details include, in relation to sensitive data (such as PII, PHI, and PCI), whether the data is: ready for encryption, is encrypted, an encryption start (for example a date and/or time or time period), an encryption end (for example a date and/or time or time period), an encrypted row count, a code message, an encryption confirmation, an encryption audit performed by, an encryption audit performed on (for example a date and/or time or time period), an encryption audit comment, a data ready for transfer indication, a data inserted by, and a data inserted on indication. Other encryption details are possible.

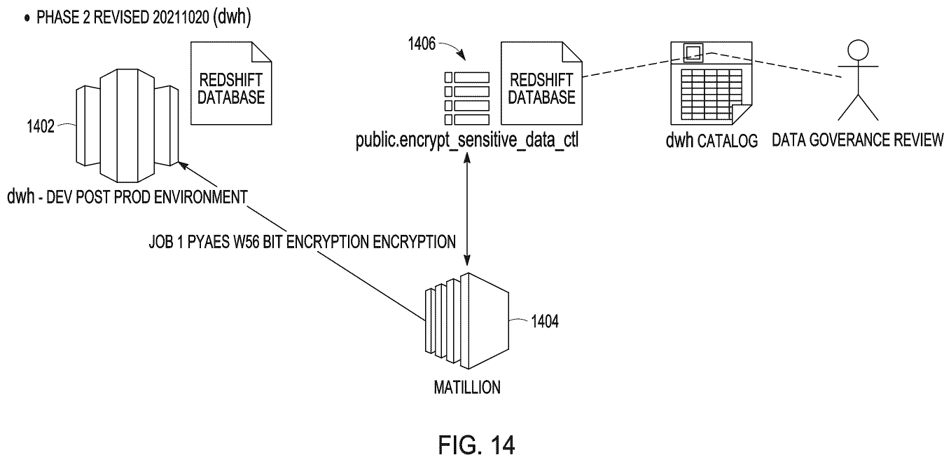

FIG. 13 illustrates in tabular form example results after an encryption task is performed. In the encryption results table 1302, the table columns 1304 and 1306, indicating “firstname” and “lastname,” have been fully encrypted. The identification of a patient's first name and last name fall within the ambit of PII compliance requirements and have been completely anonymized. As shown at 1308, a degree of encryption or anonymity of a given first or last name can run from 6 to 16 meaningless characters. The encryption results table 1302 illustrates an ability of a data aggregator and anonymizer to aggregate complex data from a great number of disparate sources for test or analysis purposes, yet render anonymous any sensitive information, such as PII, PHI, and PCI. In some examples, this rich collection of anonymous data allows a realistic simulation of production environments in which to test a new product, service, or online functionality, for example. The rich body of data may be used in these regards by one or more of the tenants 744, a third-party data analyzer 705, and the data aggregator and anonymizer 731, for example. Other users and uses of the data are possible.

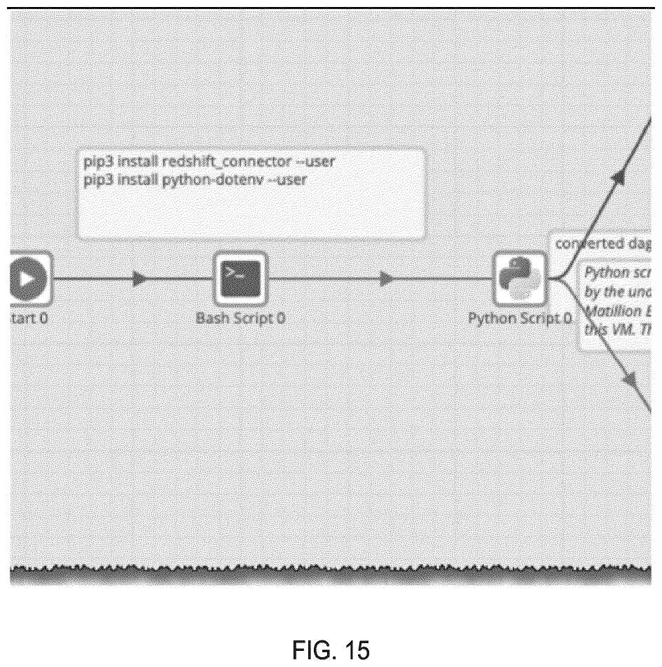

With reference to FIG. 14, further examples of data production structures are shown. Aggregated data may be stored in a data warehouse 1402. An encryption engine 1404, in this case running on Matillion™ software, classifies and encrypts identified layers of sensitive data at 1406. This encryption is performed directly on data structures at relatively high levels of data residing closer to production systems, instead of relatively lower levels. This provides a shortcut, as it were, enabling an encryption of data before it is transported or used at lower levels.

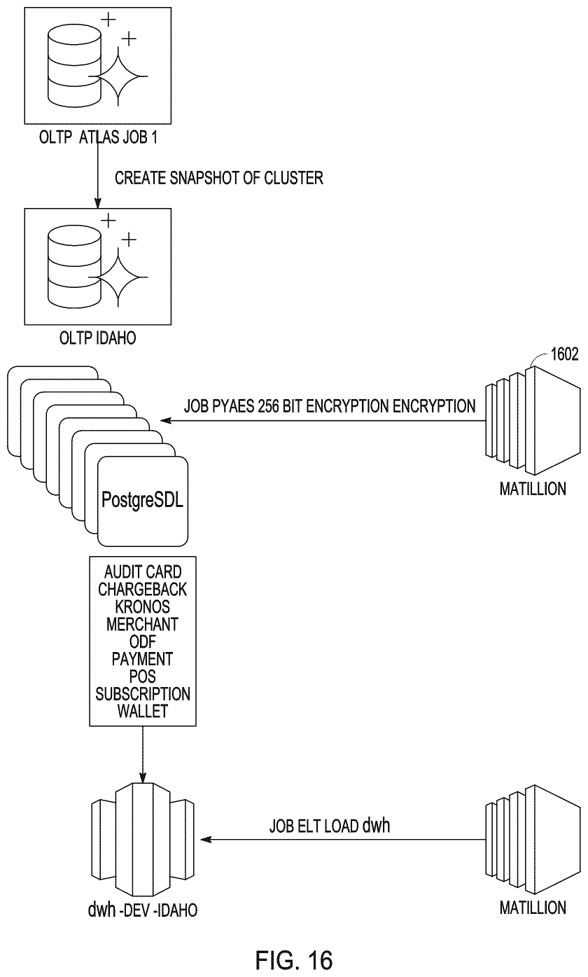

FIGS. 15-16 illustrate example procedures in this regard. FIG. 15 illustrates example operations in a Matillion™-based orchestration job hand-written in a Python computer software development language illustrated at 1404 (FIG. 14) and at 1602 in FIG. 16 as Matillion™ JOB PYEAS 556-bit encryption. FIG. 16 further illustrates a capability of the Matillion™ orchestration job hand-written in a Python computer software development language in that it can apply the encryption based on the instructions in the control table directly on the OLTP data stores in PostgreSQL. It also has the capability of applying encryption directly on the OLAP Datawarehouse tables in Redshift data stores.

Some third-party data analyzers 705 are highly specialized in the data analysis functions they perform and solutions they can provide. It may be that a tenant 744 or the subscription service 703 is unable to engineer similar solutions. If tenant data is supplied to the third-party data analyzer by the subscription service and the third-party is hacked, this can cause a very problematic situation. The tenant has lost valuable and sensitive information, very likely incurred liability, and lost credibility with its patients. In the current era, identify theft is unfortunately on the increase. In the event of a data breach, the subscription service will very likely be exposed to privacy invasion claims and damage, especially if it did not exercise a duty of care and take reasonable steps to protect the information. In some instances, prior attempts that seek to counter this threat have included encrypting “everything.” But wholly encrypted data loses its richness and meaning for test purposes. Much of the value of aggregated data is lost. Simulated production data loses a significant degree of realism.

Thus, examples of the present disclosure employ a different approach and do not encrypt “everything.” Examples enable a full test experience while protecting only that which needs to be protected. Data is still represented in a way that third parties can consume it and add their value. Data is not obfuscated so much that third parties cannot use it. Meaningful big data processing, aggregations, transformations, and similar operations can still take place without disclosure of sensitive information. Many, if not all, layers of anonymized data can safely be invoked. When analysis results are generated, a subscription service 703 can identify appropriate pieces of data and selectively decrypt them to reconstitute the original data that was sourced from a tenant and render and return unencrypted results in a meaningful way.

Partial encryption, as opposed to full encryption, can present special technical challenges where sensitive data is mixed in with other data and the sources of data are all different in terms of content and configuration. Example solutions for these problems are discussed above, and while technically challenging to implement, they offer a smooth user experience. In some instances, the only change a user (e.g., a tenant 744 or data analyzer 705) might experience differently in a test session is an anonymity in some data. UIs and databases will still operate in the same way as in real-life production, but sensitive data has been securely encrypted or anonymized. Existing APIs will still work. Moreover, in some examples, access to protected test data is facilitated. For example, a third-party data analyzer 705 engaged by a tenant 744 to conduct data analysis and testing can access APIs exposed by the subscription service 703 to pull aggregated encrypted data for testing and analysis. The data may be requested via a UI instructing the data aggregator and anonymizer 731 and retrieved from the databases 732. After processing, portions of the data may be returned to the tenant and decrypted on presentation.

Thus, in some examples, there is provided a data aggregator and anonymizer for selective encryption of test data, the data aggregator and anonymizer comprising: a processor; and a memory storing instructions that, when executed by the processor, configure the data aggregator and anonymizer to perform operations including: receiving first order data from a first data source, the first order data including a mix of sensitive and non-sensitive information, the sensitive information including one or more of PII, PHI, and PCI information; receiving second order data from a second data source, the second order data including a different mix of sensitive and non-sensitive information, the sensitive information including one or more of PII, PHI, and PCI information; combining and storing the first and second order data into an aggregated data structure, the aggregated data structure including layers in which stored data resides; identifying the sensitive information; encrypting identified sensitive information stored in at least one layer of the aggregated data structure to create an anonymous body of test data; storing the anonymous body of test data in a database; and providing access to the anonymous body of test data to the first or second data source or a third-party data analyzer.

In some examples, encrypting the identified sensitive information includes applying an encryption to a first layer of the aggregated data structure, rendering sensitive data included in the first layer anonymous.

In some examples, the first layer of the aggregated data structure is lower than a higher second layer in the aggregated data structure and a user access to the lower first layer is wider than user access to the higher second layer.

In some examples, sensitive data residing in the second layer in the aggregated data structure is not encrypted in the second layer and user access thereto is unrestricted.

In some examples, the operations further comprise decrypting a processed portion of the anonymous body of test data when delivering or presenting the processed portion to one of the first and second data sources.

In some examples, the first and second data sources are first and second tenants in a multitenant network; and the data aggregator and anonymizer resides at a subscription service to which the first and second tenants subscribe.

Thus, in some examples, there is provided a system comprising a processor; and a memory storing instructions that, when executed by the processor, cause the system to perform operations comprising: receiving a transaction request that comprises a set of transaction data; based on the set of transaction data, accessing a set of historical transaction data, the set of historical data having been aggregated from one or more historical data sources, the one more historical data sources including at least one microservice database collecting a particular aspect of transactional data processed by a corresponding microservice in support of a tenant in a multitenant environment; anonymizing the set of historical transaction data; generating a weight score for each data source of the one or more historical data sources to produce one or more weight scores; generating a fraud score for the set of transaction data, the fraud score generated using a machine-learning model trained to analyze the historical transaction data and the one or more weight scores for the one or more historical data sources; determining whether the fraud score surpasses a threshold score; and in response to determining that the fraud score surpasses the threshold score, voiding the transaction request.

In some examples, the set of transaction data comprises at least one of customer data, payment data, card data, and product data.

In some examples, the machine-learning model is a first machine-learning model, and the one or more weight scores are generated using a second machine-learning model.

In some examples, the one or more weight scores are values between 0 and 1.

In some examples, the operations further comprise, based on the one or more weight scores, removing a subset of data sources from the one or more historical data sources.

In some examples, the operations further comprise storing the set of transaction data in at least one of the one or more historical data sources.

In some examples, the one or more historical data sources comprise at least one of a customer database, a payment database, a card database, and a product database.

In some examples, the fraud score comprises a value between 0 and 1.

Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

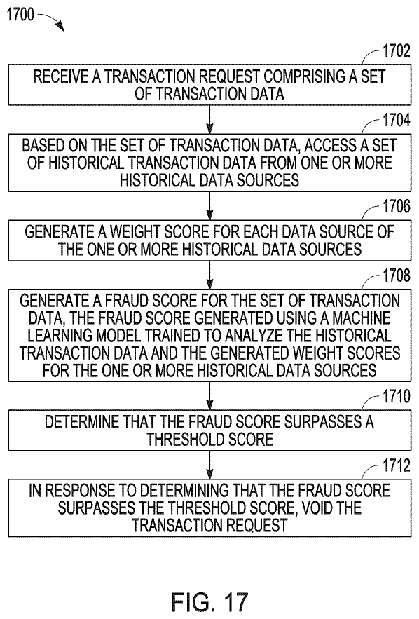

FIG. 17 is a method 1700 for detecting fraudulent card transactions, according to some embodiments. In one example, the processor in a fraud detection client 126, the processor in the client device 104, the processor in the point-of-sale server system 102, the processor in the fraud detection server 118, or any combination thereof, can perform the operations in the method 1700. In some examples, the operations of method 1700 may be performed as a series of API calls.

At operation 1702, the fraud detection server 118 receives, by a hardware processor, a transaction request. The transaction request comprises a set of transaction data. The set of transaction data may include card data, customer data, payment data, and product data. Card data is information about the credit card or debit card used in the transaction (e.g., account number, timestamp of transaction, etc.). Customer data includes information about the person completing the transaction. For example, the customer data may include personal identifiable information about the customer. The payment data includes information about the payments the customer has made. The product data includes data about the product that was purchased during the transaction. For example, the product data may include a quantity of the product that was purchased.

At operation 1704, based on the set of transaction data, the fraud detection server 118 accesses a set of historical transaction data from one or more historical data sources. The historical data sources are databases that store previous transaction data. For example, the historical data sources include a card database that stores card data, a payment database that stores payment data, a customer database that stores customer data, and a product database that stores product data. In some examples, the set of transaction data associated with the transaction request is stored in the historical data sources. In some examples, the set of historical data has been aggregated from one or more historical data sources, the one more historical data sources including at least one microservice database collecting a particular aspect of transactional data processed by a corresponding microservice in support of a tenant in a multitenant environment. Some examples anonymize the set of historical transaction data.

At operation 1706, the fraud detection server 118 generates a weight score for each data source of the one or more historical data sources. For example, the weight score may be a value between 0 and 1. The weight score is dependent on the quality of data in the one or more historical data sources. The quality of data may be dependent on the amount of available data. For example, if the product database does not have any historical data about a particular product that was purchased as part of a transaction, then the fraud detection server 118 may assign it a weight score equal to zero. In another example, if the payment database has at least some datapoints describing previous transactions made by the particular customer who is completing the transaction, then the payment database may be assigned a score of 0.4. In some examples, the weight score is generated using a machine-learning model. The machine-learning model may generate the weight score by comparing the set of transaction data associated with the received transaction request with the historical transaction data from the one or more historical data sources.

At operation 1708, the fraud detection server 118 generates a fraud score for the transaction request. The fraud score is generated using a machine-learning model trained to analyze the historical transaction data and the generated weight scores for the one or more historical data sources. For example, the machine-learning model receives the transaction data associated with the transaction request as input and analyzes the generated weight scores for the one or more historical data sources. The fraud detection server 118 subsequently outputs a fraud score based on the analysis. The machine-learning model may include the trained machine-learning program 306.

In some examples, based on the generated weight scores of the one or more historical data sources, the fraud detection server 118 removes a subset of data sources from the one or more historical data sources. For example, the fraud detection server 118 may remove any data source that is assigned a weight score of zero. In that example, the fraud detection server 118 does not analyze any data source that is assigned a weight score of zero when generating a fraud score.

At operation 1710, the fraud detection server 118 determines that the fraud score surpasses a threshold score. The threshold score can be a lower bound or an upper bound that must be surpassed. In some embodiments, the fraud score must be below a threshold score and in some embodiments the fraud score must be above a threshold score.

At operation 1712, in response to determining that the fraud score surpasses the threshold score, the fraud detection server 118 voids the transaction request. The generated fraud score may be a value between 0 and 1. The threshold score may be 0.6. Thus, if the fraud score is at or above 0.6, the fraud detection server 118 may void the transaction. If the fraud score is between 0 and 0.5, the fraud detection server 118 may validate and process the transaction.

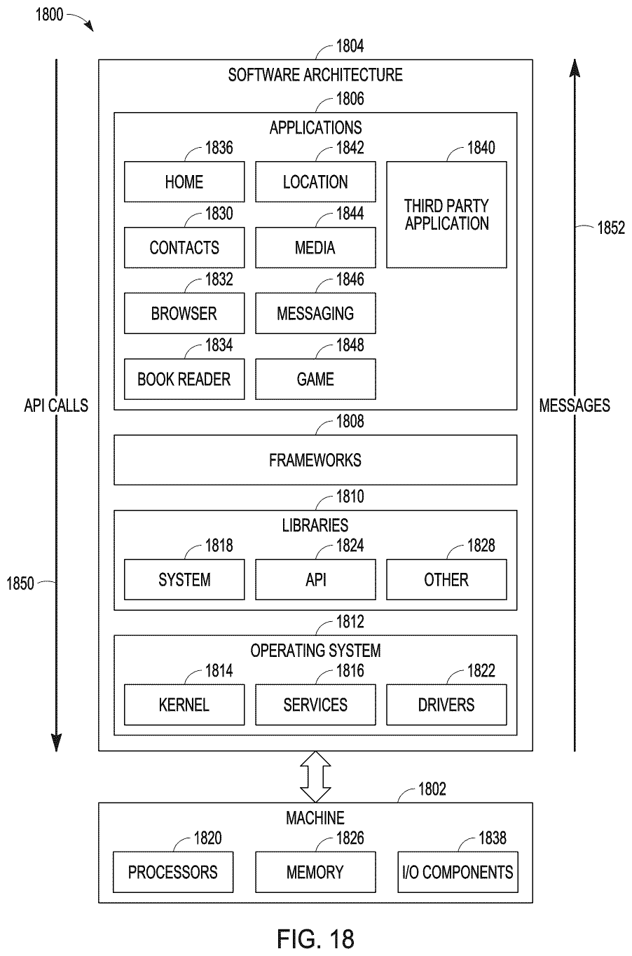

FIG. 18 is a block diagram 1800 illustrating a software architecture 1804, which can be installed on any one or more of the devices described herein. The software architecture 1804 is supported by hardware such as a machine 1802 that includes processors 1820, memory 1826, and I/O components 1838. In this example, the software architecture 1804 can be conceptualized as a stack of layers, where each layer provides a particular functionality. The software architecture 1804 includes layers such as an operating system 1812, libraries 1810, frameworks 1808, and applications 1806. Operationally, the applications 1806 invoke API calls 1850 through the software stack and receive messages 1852 in response to the API calls 1850.

The operating system 1812 manages hardware resources and provides common services. The operating system 1812 includes, for example, a kernel 1814, services 1816, and drivers 1822. The kernel 1814 acts as an abstraction layer between the hardware and the other software layers. For example, the kernel 1814 provides memory management, processor management (e.g., scheduling), component management, networking, and security settings, among other functionality. The services 1816 can provide other common services for the other software layers. The drivers 1822 are responsible for controlling or interfacing with the underlying hardware. For instance, the drivers 1822 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1810 provide a low-level common infrastructure used by the applications 1806. The libraries 1810 can include system libraries 1818 (e.g., C standard library) that provide functions such as memory allocation functions, string manipulation functions, mathematic functions, and the like. In addition, the libraries 1810 can include API libraries 1824 such as media libraries (e.g., libraries to support presentation and manipulation of various media formats such as Moving Picture Experts Group-4 (MPEG4), Advanced Video Coding (H.364 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1810 can also include a wide variety of other libraries 1828 to provide many other APIs to the applications 1806.

The frameworks 1808 provide a high-level common infrastructure that is used by the applications 1806. For example, the frameworks 1808 provide various graphical user interface (GUI) functions, high-level resource management, and high-level location services. The frameworks 1808 can provide a broad spectrum of other APIs that can be used by the applications 1806, some of which may be specific to a particular operating system or platform.

For some embodiments, the applications 1806 may include a home application 1836, a contacts application 1830, a browser application 1832, a book reader application 1834, a location application 1842, a media application 1844, a messaging application 1846, a game application 1848, and a broad assortment of other applications such as a third-party application 1840. The applications 1806 are programs that execute functions defined in the programs. Various programming languages can be employed to create one or more of the applications 1806, structured in a variety of manners, such as object-oriented programming languages (e.g., Objective-C, Java, or C++) or procedural programming languages (e.g., C or assembly language). In a specific example, the third-party application 1840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1840 can invoke the API calls 1850 provided by the operating system 1812 to facilitate functionality described herein.

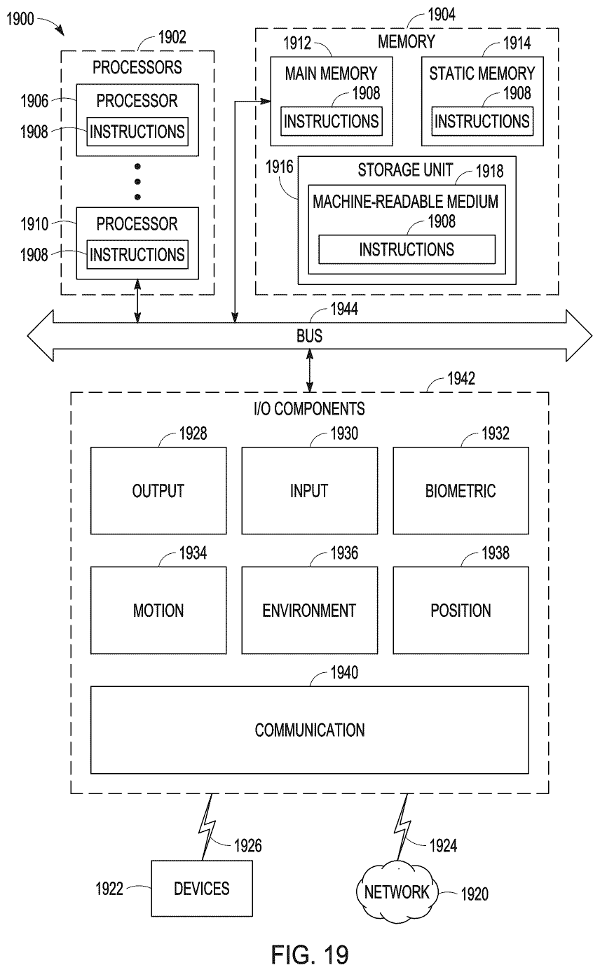

FIG. 19 is a diagrammatic representation of the machine 1900 within which instructions 1908 (e.g., software, a program, an application, an applet, an app, or other executable code) for causing the machine 1900 to perform any one or more of the methodologies discussed herein may be executed. For example, the instructions 1908 may cause the machine 1900 to execute any one or more of the methods described herein. The instructions 1908 transform the general, non-programmed machine 1900 into a particular machine 1900 programmed to carry out the described and illustrated functions in the manner described. The machine 1900 may operate as a standalone device or may be coupled (e.g., networked) to other machines. In a networked deployment, the machine 1900 may operate in the capacity of a server machine or a client machine in a server-client network environment, or as a peer machine in a peer-to-peer (or distributed) network environment. The machine 1900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1908, sequentially or otherwise, that specify actions to be taken by the machine 1900. Further, while only a single machine 1900 is illustrated, the term “machine” shall also be taken to include a collection of machines that individually or jointly execute the instructions 1908 to perform any one or more of the methodologies discussed herein.

The machine 1900 may include processors 1902, memory 1904, and I/O components 1942, which may be configured to communicate with each other via a bus 1944. For some embodiments, the processors 1902 (e.g., a CPU, a Reduced Instruction Set Computing (RISC) processor, a Complex Instruction Set Computing (CISC) processor, a GPU, a Digital Signal Processor (DSP), an ASIC, a Radio-Frequency Integrated Circuit (RFIC), another processor, or any suitable combination thereof) may include, for example, a processor 1906 and a processor 1910 that execute the instructions 1908. The term “processor” is intended to include multi-core processors that may comprise two or more independent processors (sometimes referred to as “cores”) that may execute instructions contemporaneously. Although FIG. 19 shows multiple processors 1902, the machine 1900 may include a single processor with a single core, a single processor with multiple cores (e.g., a multi-core processor), multiple processors with a single core, multiple processors with multiples cores, or any combination thereof.

The memory 1904 includes a main memory 1912, a static memory 1914, and a storage unit 1916, all accessible to the processors 1902 via the bus 1944. The main memory 1912, the static memory 1914, and storage unit 1916 store the instructions 1908 embodying any one or more of the methodologies or functions described herein. The instructions 1908 may also reside, completely or partially, within the main memory 1912, within the static memory 1914, within machine-readable medium 1918 within the storage unit 1916, within at least one of the processors 1902 (e.g., within the processor's cache memory), or any suitable combination thereof, during execution thereof by the machine 3000.

The I/O components 1942 may include a wide variety of components to receive input, provide output, produce output, transmit information, exchange information, capture measurements, and so on. The specific I/O components 1942 that are included in a particular machine will depend on the type of machine. For example, portable machines such as mobile phones may include a touch input device or other such input mechanisms, while a headless server machine will likely not include such a touch input device. It will be appreciated that the I/O components 1942 may include many other components that are not shown in FIG. 19. In various embodiments, the I/O components 1942 may include output components 1928 and input components 1930. The output components 1928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1942 may include biometric components 1932, motion components 1934, environmental components 1936, or position components 1938, among a wide array of other components. For example, the biometric components 1932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1934 include acceleration sensor components (e.g., accelerometer), gravitation sensor components, rotation sensor components (e.g., gyroscope), and so forth. The environmental components 1936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1938 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1942 further include communication components 1940 operable to couple the machine 1900 to a network 1920 or devices 1922 via a coupling 1924 and a coupling 1926, respectively. For example, the communication components 1940 may include a network interface component or another suitable device to interface with the network 1920. In further examples, the communication components 1940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1922 may be another machine or any of a wide variety of peripheral devices (e.g., a peripheral device coupled via a USB).

Moreover, the communication components 1940 may detect identifiers or include components operable to detect identifiers. For example, the communication components 1940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1940, such as location via Internet Protocol (IP) geolocation, location via Wi-Fi® signal triangulation, location via detecting an NFC beacon signal that may indicate a particular location, and so forth.

The various memories (e.g., memory 1904, main memory 1912, static memory 1914 and/or memory of the processors 1902) and/or storage unit 1916 may store one or more sets of instructions and data structures (e.g., software) embodying or used by any one or more of the methodologies or functions described herein. These instructions (e.g., the instructions 1908), when executed by processors 1902, cause various operations to implement the disclosed embodiments.

The instructions 1908 may be transmitted or received over the network 1920, using a transmission medium, via a network interface device (e.g., a network interface component included in the communication components 1940) and using any one of a number of well-known transfer protocols (e.g., HTTP). Similarly, the instructions 1908 may be transmitted or received using a transmission medium via the coupling 1924 (e.g., a peer-to-peer coupling) to the devices 1922.

“Computer-readable storage medium” refers to both machine-storage media and transmission media. Thus, the terms include both storage devices/media and carrier waves/modulated data signals. The terms “machine-readable medium,” “computer-readable medium,” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving, by a hardware processor, a transaction request that comprises a set of transaction data;
based on the set of transaction data, accessing, by the hardware processor, a set of historical transaction data, the set of historical transaction data having been aggregated from one or more historical data sources, the one or more historical data sources including at least one microservice database collecting a particular aspect of transactional data processed by a corresponding microservice in support of a tenant in a multitenant environment;
anonymizing the set of historical transaction data;
generating, by the hardware processor, a weight score for each data source of the one or more historical data sources to produce one or more weight scores;
generating, by the hardware processor, a fraud score for the set of transaction data, the fraud score generated using a machine-learning model trained to analyze the set of historical transaction data and the one or more weight scores for the one or more historical data sources;
determining, by the hardware processor, that the fraud score surpasses a threshold score; and
in response to determining that the fraud score surpasses the threshold score, voiding, by the hardware processor, the transaction request.

2. The method of claim 1, wherein the machine-learning model is a first machine-learning model; and
wherein the one or more weight scores are generated using a second machine-learning model.

3. The method of claim 1, further comprising:
based on the one or more weight scores, removing, by the hardware processor, a subset of data sources from the one or more historical data sources.

4. The method of claim 1, further comprising:
storing, by the hardware processor, the set of transaction data in at least one of the one or more historical data sources.

5. The method of claim 1, wherein the one or more historical data sources comprise at least one of a customer database, a payment database, a card database, and a product database.

6. The method of claim 1, wherein the fraud score comprises a value between 0 and 1.

7. The method of claim 1, wherein the weight score for each data source of the one or more historical data sources is generated based on an amount of available data associated with each data source.

8. A system comprising:
a processor; and
a memory storing instructions that, when executed by the processor, cause the system to perform operations comprising:
receiving a transaction request that comprises a set of transaction data;
based on the set of transaction data, accessing a set of historical transaction data, the set of historical transaction data having been aggregated from one or more historical data sources, the one or more historical data sources including at least one microservice database collecting a particular aspect of transactional data processed by a corresponding microservice in support of a tenant in a multitenant environment;
anonymizing the set of historical transaction data;
generating a weight score for each data source of the one or more historical data sources to produce one or more weight scores;
generating a fraud score for the set of transaction data, the fraud score generated using a machine-learning model trained to analyze the set of historical transaction data and the one or more weight scores for the one or more historical data sources;
determining whether the fraud score surpasses a threshold score; and
in response to determining that the fraud score surpasses the threshold score, void the transaction request.

9. The system of claim 8, wherein the set of transaction data comprises at least one of customer data, payment data, card data, and product data.

10. The system of claim 8, wherein the machine-learning model is a first machine-learning model; and
wherein the one or more weight scores are generated use a second machine-learning model.

11. The system of claim 8, wherein the one or more weight scores are values between 0 and 1.

12. The system of claim 8, wherein the operations further comprise;
based on the one or more weight scores, removing a subset of data sources from the one or more historical data sources.

13. The system of claim 8, wherein the operations further comprise:
storing the set of transaction data in at least one of the one or more historical data sources.

14. The system of claim 8, wherein the one or more historical data sources comprise at least one of a customer database, a payment database, a card database, and a product database.

15. The system of claim 8, wherein the fraud score comprises a value between 0 and 1.

16. A non-transitory computer-readable storage medium, the non-transitory computer-readable storage medium including instructions that when executed by a processing device, cause the processing device to perform operations comprising:
receiving a transaction request that comprises a set of transaction data;
based on the set of transaction data, accessing a set of historical transaction data, the set of historical transaction data having been aggregated from one or more historical data sources, the one or more historical data sources including at least one microservice database collecting a particular aspect of transactional data processed by a corresponding microservice in support of a tenant in a multitenant environment;
anonymizing the set of historical transaction data;
generating a weight score for each data source of the one or more historical data sources to produce one or more weight scores;
generating a fraud score for the set of transaction data, the fraud score generated using a machine-learning model trained to analyze the set of historical transaction data and the one or more weight scores for the one or more historical data sources;
determining whether the fraud score surpasses a threshold score; and
in response to determining that the fraud score surpasses the threshold score, voiding the transaction request.

17. The non-transitory computer-readable storage medium of claim 16, wherein the set of transaction data comprises at least one of customer data, payment data, card data, and product data.

18. The non-transitory computer-readable storage medium of claim 16, wherein the machine-learning model is a first machine-learning model; and
wherein the one or more weight scores are generated use a second machine-learning model.

19. The non-transitory computer-readable storage medium of claim 16, wherein the operations further comprise;
based on the one or more weight scores, removing a subset of data sources from the one or more historical data sources.

20. The non-transitory computer-readable storage medium of claim 16, wherein the operations further comprise:
storing the set of transaction data in at least one of the one or more historical data sources.
